(19) United States
(12) Patent Application Publication
(10) Pub. No.: US 2019/0101236 A1
(43) Pub. Date: Apr. 4, 2019

(54) Vapour Barrier Lamina

(71) Applicant: Pyrotek Pty. Limited, Girraween (AU)

(72) Inventor: George Tsitos, New South Wales (AU)

(73) Assignee: Pyrotek Pty. Limited, Girraween (AU)

(21) Appl. No.: 16/143,829

(22) Filed: Sep. 27, 2018

(30) Foreign Application Priority Data
Sep. 29, 2017 (AU) 2017903961

(51) Int. Cl. F16L 55/033; F16L 59/14; F16L 59/02

(52) U.S. Cl. CPC F16L 55/0336; B32B 27/12; F16L 59/029; F16L 59/145

(57) ABSTRACT

A vapour barrier lamina, particularly for acoustic insulation of a pipe or duct, including a fiberglass moisture-proof foil layer, an acoustic insulation layer adjacent a first side of the moisture-proof layer, and a protection layer adjacent a second side of the moisture-proof layer. The vapour barrier lamina may also include a structural layer located between the moisture-proof foil layer and the acoustic insulation layer, for additional protection, and the structural layer may be a fiberglass screen.

### FIELD

The present invention relates to a vapour barrier lamina, in particular to a vapour barrier lamina for acoustic insulation of a pipe or duct.

### BACKGROUND

The increasing worldwide demand for cleaner energy sources has led to a sharp increase in the production, processing, transport and consumption of Liquefied Natural Gas (LNG). The industrial facilities handling LNG require extensive industrial insulation to avoid problems such as boil-off, ice build-up and associated fire hazards. It is not uncommon for a cryogenic pipe to operate at a temperature of −168° C. (−334° F.) in ambient conditions of 32° C. (90° F.), requiring extensive insulation.

However, the temperature gradient also creates a considerable natural moisture drive towards the cryogenic pipe. Moisture intrusion into the insulation layers degrades insulation performance, while causing ice build-up. Additionally, moisture intrusion can cause corrosion of the cryogenic pipe under the insulation layer, which is a significant safety hazard.

An additional consideration that has developed in the design of cryogenic pipework is noise pollution. The compressors, reducers, expanders, valves and other pipework accessories are significant source of noise. The noise is detrimental to the structural integrity of the cryogenic pipe, due to vibrations causing fatigue, as well as detrimental to the human working environment. If noise levels are above 85 dBA, reduced working hours or cumbersome personal protective equipment are generally mandated by workplace regulators. Acoustic insulation is also desirable in non-cryogenic applications where waterproofing or vapour proofing may be required.

The current approach to prevent moisture intrusion and acoustic insulation involves cladding the cryogenic pipe first with a thermal insulation layer, then apply an acoustic insulation layer, and finally a moisture-proof foil. This is a very labour intensive process referred to as fabrication. Frequently, the conditions require several alternating thermal and acoustic insulation layers, further increasing fabrication costs. Additionally, the manual application of each layer on-site is an error source for gaps in the insulation, or the moisture-proof foil, that may lead to moisture intrusion. This error source is difficult to control at installation, as the cryogenic pipe undergoes significant thermal shrinkage as it cools from ambient temperature to operating temperature.

### OBJECT OF THE INVENTION

It is an object of the present invention to at least substantially overcome at least one of the disadvantages described above.

### SUMMARY OF INVENTION

In a first aspect, the present invention provides a vapour barrier lamina for acoustic insulation of a pipe, the vapour barrier lamina comprising:

a moisture-proof foil layer;

an acoustic insulation layer adjacent a first side of the moisture-proof foil layer; and

a protective layer adjacent a second side of the moisture-proof foil layer.

Preferably, the acoustic insulation layer abuts the first side of the moisture-proof foil layer.

Preferably, the protective layer abuts the second side of the moisture-proof foil layer.

Preferably, the vapour barrier lamina further comprises:

a structural layer for improving the tear strength of the vapour barrier system.

Preferably, the structural layer is located between the moisture-proof foil layer and the acoustic insulation layer and provides additional protection of the moisture-proof foil layer.

Preferably, the moisture-proof foil layer is a metal foil, a polymeric film, or a silicone coated fabric.

Preferably, the vapour barrier lamina has a permeance range of 0.0875 to 7.5 ng·Pa⁻¹·s⁻¹·m⁻² (0.0015 to 0.13 perms (inch-pound)).

Preferably, the moisture-proof foil layer is made of a flame resistant material.

Preferably, the acoustic insulation layer is made of mass-loaded vinyl with operational temperature ranging from −40° C. (−40° F.) up to and greater than 93° C. (200° F.).

Preferably, the mass-loaded vinyl has a superficial density in the range of 2 kg/m² to 20 kg/m², and more preferably in the range of 2 kg/m² to 12 kg/m².

Preferably, the mass-loaded vinyl is formed from any combination or selection of polyvinyl chloride, polyethylene, polypropylene and/or ethylene vinyl acetate.

Preferably, the mass-loaded vinyl includes an inert filler.

Preferably, the inert filler is any combination or selection of calcium carbonate, barium sulphate or aluminium tri-hydrate (aluminium hydroxide).

Preferably, the structural layer is a scrim made from any combination or selection of fiberglass, polyester, polyethylene, polypropylene, or polybutylene terephthalate.

In a second aspect, the present invention provides a vapour barrier for use in insulation of cryogenic pipes, the vapour barrier consisting of a moisture-proof foil layer sandwiched between a first and a second protective layer, wherein the protective layers protect the moisture-proof foil layer against punctures.

Preferably, the moisture-proof foil layer is a metal foil, a polymeric film, or a silicone coated fabric.

Preferably, the vapour barrier has a permeance range of 0.0875 to 7.5 ng·Pa⁻¹·s⁻¹·m⁻² (0.0015 to 0.13 perms (inch-pound)).

Preferably, the moisture-proof foil layer is made of a flame resistant material.

### BRIEF DESCRIPTION OF DRAWINGS

Preferred embodiments of the present invention will now be described, by way of examples only, with reference to the accompanying drawings, wherein:

FIG. 1 is a schematic cross-section of a known vapour barrier, a known acoustic insulation layer and a known thermal insulation layer in use.

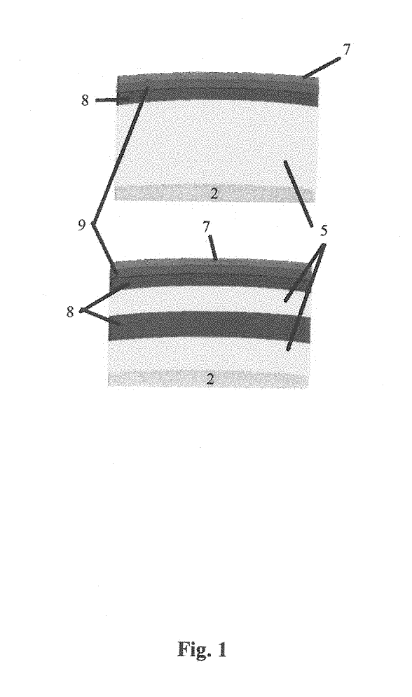

FIG. 2 is a schematic cross-section of an embodiment of a vapour barrier lamina according to the present invention.

FIG. 3 is a view of the vapour barrier lamina of FIG. 2.

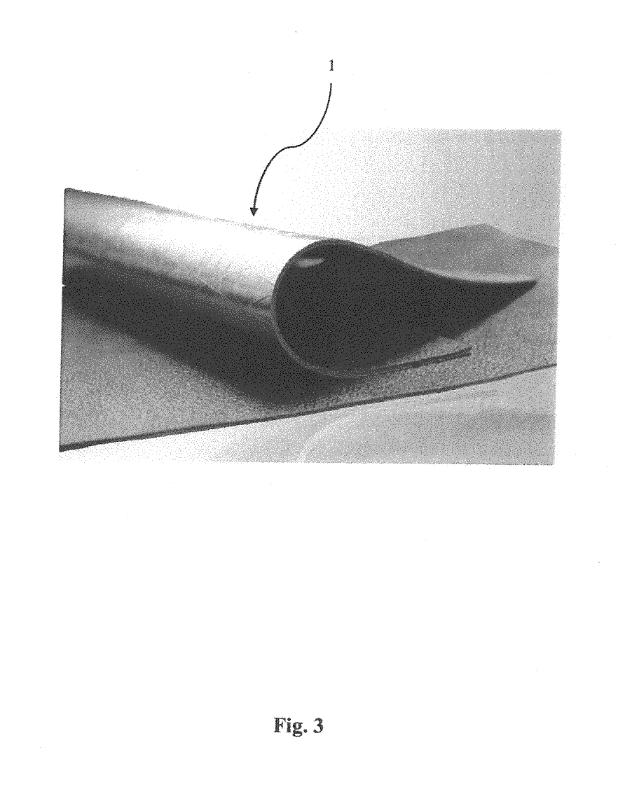

FIG. 4 is a schematic cross-section of the vapour barrier lamina of FIG. 2 in use.

### DESCRIPTION OF EMBODIMENTS

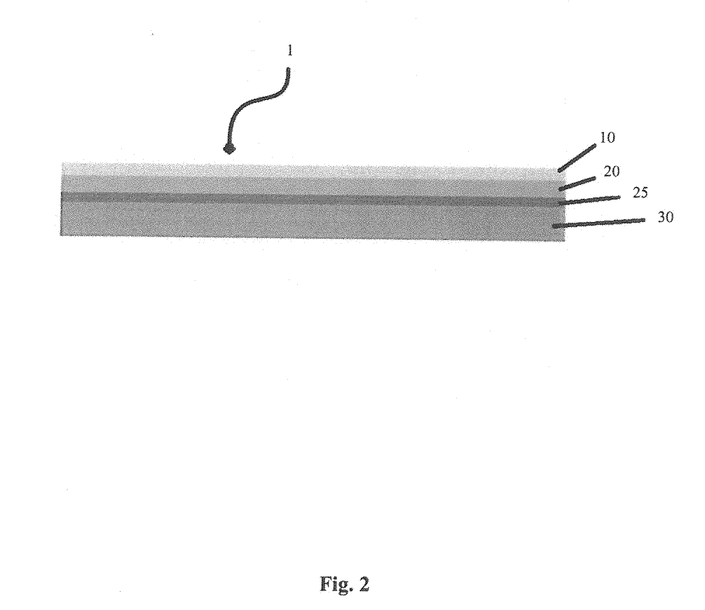

FIG. 2 shows an embodiment of a vapour barrier lamina 1 comprising a protective layer 10, a moisture-proof foil layer 20, a structural layer 25, and an acoustic insulation layer 30. As shown in FIG. 2, in this embodiment, the acoustic insulation layer 30 is made of mass-loaded plastic and the structural layer 25 is a reinforcing glass fibre scrim.

The moisture-proof foil layer 20 may be formed from a metal foil, such as aluminium foil and has a permeance in the range between 0.28-5.72 ng·Pa⁻¹·s⁻¹·m⁻² (0.005-0.1 Perms (inch-pound)) (ASTM E96). The moisture-proof foil layer 20 may alternatively be formed from polymeric films, such as polyethylene, polyvinyl chloride or acetates, polypropylene, polyester, or silicone coated fabrics.

The mass-loaded vinyl (MLV) may be made using polyvinyl chloride (PVC), polyethylene, polypropylene and/or ethylene vinyl acetate. The mass-loaded plastic may be loaded with an inert mineral filler such as calcium carbonate, barium sulphate and/or aluminium tri-hydrate (aluminium hydroxide). The acoustic insulation layer 30, in this embodiment, has a superficial density in the range of 2 kg/m² to 20 kg/m². In another embodiment the superficial density is in the range of 2 kg/m² to 12 kg/m².

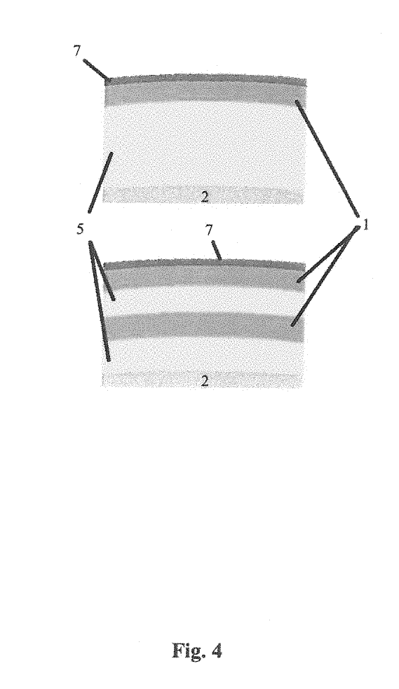

There is also herein disclosed, as shown in FIG. 4, in combination a pipe 2 with a thermal insulation layer 5, the vapour barrier lamina 1 and a cladding 7.

Use of the vapour barrier lamina 1 will now be described.

As shown in FIG. 4, the pipe 2, when it is used in cryogenic applications, is typically surrounded by the thermal insulation layer 5 and the cladding 7. The thermal insulation layer 5 is typically a foam glass or rockwool product. The vapour barrier lamina 1 is installed after the thermal insulation layer 5 has been placed on the cryogenic pipe 2. The cladding 7 is then installed to provide long-term protection.

Advantages of the vapour barrier lamina 1 will now be discussed.

As the vapour barrier lamina 1 includes both the acoustic insulation layer 30 as well as the moisture-proof foil layer 20, acoustic and moisture insulation can be provided in a single step, as opposed to the sequential fabrication process presently known. This substantially reduces fabrication costs and reduces the error incidence during joint fabrication. Additionally, the single lamina construction improves the dimensional stability of the applied layers 10, 20, 25, 30 when the cryogenic pipe 2 is brought to operating temperature.

The protective layer 10, the structural layer 25 and the acoustic insulation layer 30 protect the moisture-proof foil layer 20 from damage, particularly punctures, during production, transport and fabrication. To further improve the structural performance of the vapour barrier lamina 1, the structural layer 25 provides the vapour barrier lamina 1 with increased tear strength.

The moisture-proof foil layer 20 also provides flame resistance and a low velocity of flame surface spreading, which is critical in applications involving LNG.

Although the invention has been described with reference to specific examples, it will be appreciated by those skilled in the art that the invention may be embodied in many other forms.

For example, the acoustic insulation layer could be replaced by another protective film for use cases where acoustic insulation is not required.

1. A vapour barrier lamina for acoustic insulation of a pipe, the vapour barrier lamina comprising:
a moisture-proof foil layer;
an acoustic insulation layer adjacent a first side of the moisture-proof foil layer; and
a protective layer adjacent a second side of the moisture-proof layer.

2. The vapour barrier lamina of claim 1, wherein the acoustic insulation layer abuts the first side of the moisture-proof foil layer.

3. The vapour barrier lamina of claim 1, wherein the protective layer abuts the second side of the moisture-proof foil layer.

4. The vapour barrier lamina of claim 1, wherein the vapour barrier lamina further comprises:
a structural layer for improving the tear strength of the vapour barrier system.

5. The vapour barrier lamina of claim 4, wherein the structural layer is located between the moisture-proof foil layer and the acoustic insulation layer and provides additional protection of the moisture-proof foil layer.

6. The vapour barrier lamina of claim 4, wherein the structural layer is a fiberglass scrim.

7. The vapour barrier lamina of claim 1, wherein the moisture-proof foil layer is a metal foil, a polymeric film, or a silicone coated fabric.

8. The vapour barrier lamina of claim 1, wherein the vapour barrier lamina has a permeance range of 0.0875 to 7.5 ng·Pa⁻¹·s⁻¹·m⁻² (0.0015 to 0.13 perms (inch-pound)).

9. The vapour barrier lamina of claim 1, wherein the moisture-proof foil layer is made of a flame resistant material.

10. The vapour barrier lamina of claim 1, wherein the acoustic insulation layer is made of mass-loaded vinyl.

11. The vapour barrier lamina of claim 10, wherein the mass-loaded vinyl has an operational temperature range of −40° C. (−40° F.) to 93° C. (200° F.).

12. The vapour barrier lamina of claim 10, wherein the mass-loaded vinyl has a density in the range of 2 kg/m² to 12 kg/m².

13. The vapour barrier lamina of claim 10, wherein the mass-loaded vinyl is formed from any combination or selection of polyvinyl chloride, polyethylene, polypropylene and/or ethylene vinyl acetate.

14. The vapour barrier lamina of claim 10, wherein the mass-loaded vinyl includes an inert filer.

15. The vapour barrier lamina of claim 14 wherein the inert filler is any combination or selection of calcium carbonate, barium sulphate or aluminium hydroxide.

16. A vapour barrier for use in insulation of cryogenic pipes, the vapour barrier consisting of a moisture-proof foil layer sandwiched between a first and a second protective layer, wherein the protective layers protect the moisture-proof foil layer against punctures.

17. The vapour barrier of claim 16, wherein the moisture-proof foil layer is a metal foil, a polymeric film, or a silicone coated fabric.

18. The vapour barrier of claim 16, wherein the vapour barrier has a permeance range of 0.0875 to 7.5×10 ng·Pa⁻¹·s⁻¹·m⁻² (0.0015 to 0.13 perms (inch-pound)).

19. The vapour barrier of claim 16, wherein the moisture-proof foil layer is made of a flame resistant material.
